(19) United States
(12) Patent Application Publication
(10) Pub. No.: US 2014/0286245 A1
(43) Pub. Date: Sep. 25, 2014

(54) WIRELESS COMMUNICATION APPARATUS AND WIRELESS COMMUNICTION METHOD, BOTH ABLE TO TRANSMIT PSEUDO FRAMES

(71) Applicant: Kabushiki Kaisha Toshiba, (unknown)

(72) Inventor: Tomoya Suzuki, Tokyo (JP)

(73) Assignee: KABUSHIKI KAISHA TOSHIBA

(21) Appl. No.: 13/962,225

(22) Filed: Aug. 8, 2013

(30) Foreign Application Priority Data
Mar. 22, 2013 (JP) 2013-060921

(51) Int. Cl. H04W 12/02; H04W 72/04

(52) U.S. Cl. CPC H04W 12/02; H04W 72/048
USPC 370/329; 370/338

(57) ABSTRACT

According to one embodiment, a wireless communication apparatus includes a detecting unit, a generation unit and a transmission unit. The detecting unit detects whether a registered station is communicating. The generation unit generates a pseudo frame similar to a frame the registered station transmits and receives, if the station is detected not communicating. The transmission unit transmits the pseudo frame generated by the generation unit.

### CROSS-REFERENCE TO RELATED APPLICATIONS

This application is based upon and claims the benefit of priority from Japanese Patent Application No. 2013-060921, filed Mar. 22, 2013, the entire contents of which are incorporated herein by reference.

### FIELD

Embodiments described herein relate generally to a wireless communication apparatus such as wireless local area network (LAN), and a wireless communication method.

### BACKGROUND

Wireless LANs are used as wireless communication apparatuses. In the wireless LAN, the communication data can be encrypted and therefore communication contents can be protected. Nonetheless, whether the wireless LAN is performing communication or not can be detected by a third party. Furthermore, since the media access control (MAC) address cannot be encrypted, the third party can determine which station is communicating. Consequently, by the state of communication with the station, it can be detected from outside whether the user of the station is at home or not, and the life situations of the user of the station.

### BRIEF DESCRIPTION OF THE DRAWINGS

FIG. 1A and FIG. 1B are diagrams for explaining an exemplary communication traffic of ordinary type;

FIG. 2 is a schematic diagram showing a wireless communication apparatus according to an embodiment;

FIG. 3 is a diagram showing an exemplary configuration of the wireless communication apparatus according to the embodiment;

FIG. 4 is a configuration diagram showing a section of the wireless communication apparatus of FIG. 3;

FIG. 5 is a sequence chart explaining an exemplary operation performed by the wireless communication apparatus according to the embodiment; and

FIG. 6A and FIG. 6B are diagrams explaining an exemplary communication traffic observed at the wireless communication apparatus according to an embodiment.

### DETAILED DESCRIPTION

In general, according to one embodiment, a wireless communication apparatus includes a detecting unit, a generation unit and a transmission unit. The detecting unit detects whether a registered station is communicating. The generation unit generates a pseudo frame similar to a frame the registered station transmits and receives, if the station is detected not communicating. The transmission unit transmits the pseudo frame generated by the generation unit.

As mentioned above, if the state of communication with any station is detected, whether the user of the station is at home or not can be detected from outside, merely by intercepting the communication traffic leaking from the house. This is undesirable in view of security. Furthermore, the data representing the life situation of any person may leak. Especially, traffic from smartphone to an access point (hereinafter abbreviated “AP”) may show user's life situations. The traffic may have strong correlation with activities of the user, since the user usually keeps the smartphone on him or her.

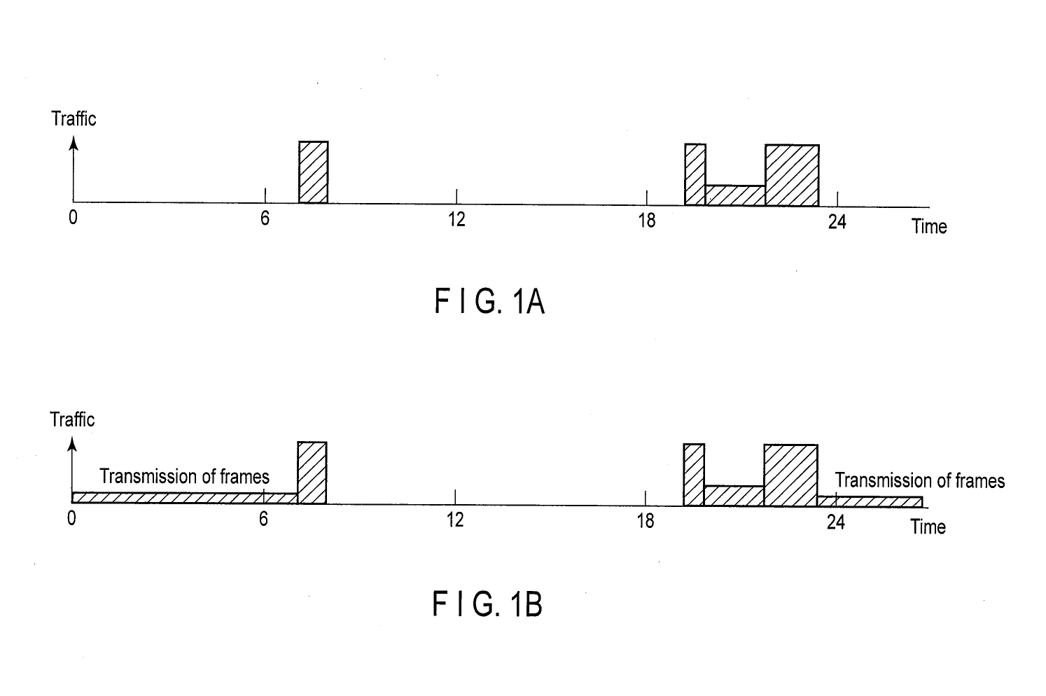

For more specific example, as shown in FIG. 1A, the traffic between the smartphone and the AP increases when the user gets up, and decreases when the user gets sleep. Thus, the data about the user's activity can be acquired from outside by observing the traffic.

Even while the user is not operating the smartphone, it may keep transmitting frames at regular intervals as shown in FIG. 1B, thereby maintaining the connection with the AP. In this case, if some frames are detected, it is known from outside that the user stays in the house. On the other hand, if any frames are not detected, it is known from outside that the user does not stay in the house. If the user is found not at home, by any person outside, it would impair the security.

Not only smartphones, but also stations of any other type involve in the same problem.

In view of this, the embodiment is configured to behave as if the station user is at home, even if the user has left home, thus making it difficult to know, from outside, the state of communication with the station.

### Embodiment

The embodiment will be described below, with reference to the accompanying drawings.

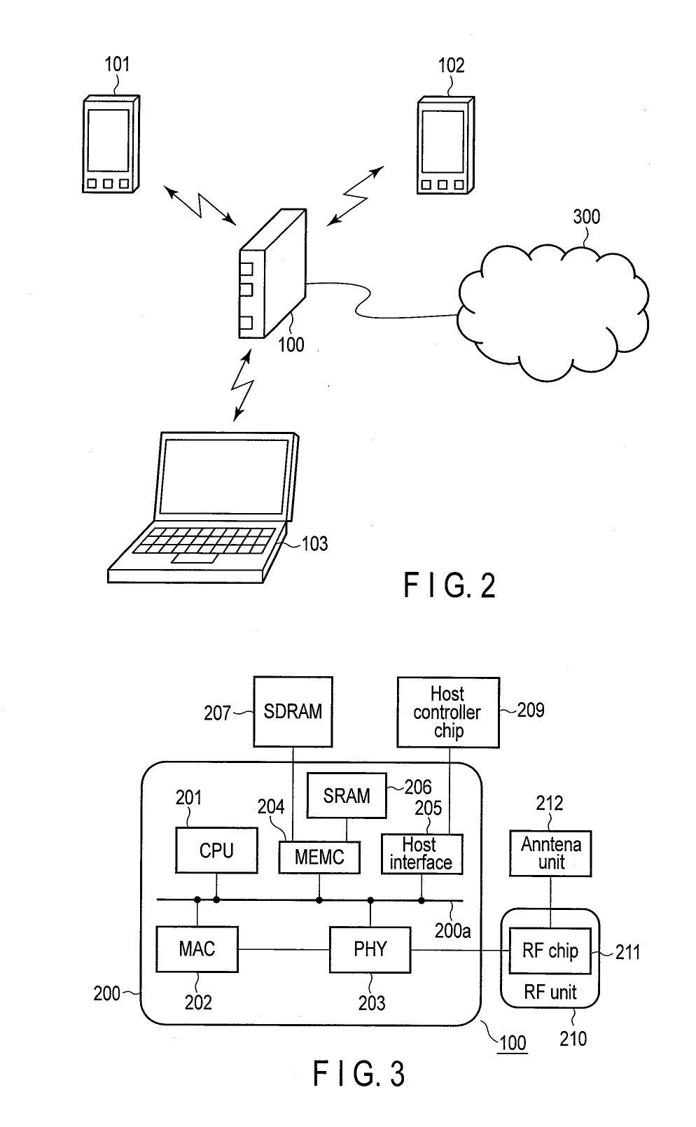

FIG. 2 shows an exemplary configuration of a wireless LAN communication system according to the embodiment. In the system, the AP 100 is access point that is, for example a wireless LAN router. The AP 100 can communicate with, for example, three stations (hereinafter referred to as “STAs (stations) 101 to 103.” The STAs 101 to 103 are stations that can communicate with the AP 100 in the wireless LAN communication system. For example, the STAs 101 and 102 are smartphones and the STA 103 is a personal computer.

The AP 100 is connected to the Internet 300 by, for example, a LAN cable. Furthermore, the AP 100 manages connection information including the MAC addresses of connected STAs 101 to 103, as will be described later.

FIG. 3 schematically shows the configuration of the AP 100. The AP 100 has a wireless LAN base-band chip 200. The wireless LAN base-band chip 200 incorporates a central processing unit (CPU) 201, a MAC 202, a physical layer (PHY) 203, a memory controller (MEMC) 204, a host interface (host IF) 205, and a static random access memory (SRAM) 206. The CPU 201, MAC 202, PHY 203, MEMC 204 and host IF 205 are mutually connected by a bus 200a.

To the PHY 203, the MAC 202 and a radio-frequency (RF) unit 210 are connected. The radio-frequency unit 210 incorporates an RF chip 211, to which an antenna unit 212 is connected.

The SRAM 206 and a synchronous dynamic random access memory (SDRAM) 207 are connected to the MEMC 204. A host controller chip 209 is connected to the host IF 205.

To transmit data from, for example, the host controller chip 209, the data supplied from the host controller chip 209 is stored in the SRAM 206 and/or the SDRAM 207 through the host interface 205 provided in the wireless LAN base-band chip 200. Accesses to the SRAM 206 and SDRAM 207 are made through the MEMC 204.

The data stored in the SRAM 206 and/or the SDRAM 207 is first processed by the CPU 201 and then output to the radio-frequency unit 210 through the MAC 202 and PHY 203. The RF chip 211 amplifies the data signal as a high-frequency signal. The signal amplified is supplied to the antenna unit 212. The antenna unit 212 transmits a wireless-LAN communication frame.

When data is received, operation is performed in a reverse order in the case where data is transmitted. Note that the STAs 101 to 103 are almost identical to the AP 100 in both configuration and operation in base-band chip.

The PHY 203 performs specific modulation and encoding that accord with, for example, the IEEE 802.11 Standard, and signal transmission and reception including demodulation and decoding such as the fast Fourier transform (FFT). In the physical layer defined in the IEEE 802.11 Standard, the spread spectrum of direct sequence type or the OFDM system is utilized. In the frequency band of 2400 to 2483.5 MHz, every 5 [MHz], 13 frequency channels, for example, are assigned, from which a desirable frequency channel is selected. In the frequency channel selected, a communication band of about 20 MHz may be used as described in the 802.11b/802.11g/802.11n Standard in some cases, and a communication band of about 40 MHz may be used as described in the 802.11n Standard in other cases.

The MAC 202 performs an access control that accords with, for example, IEEE 802.11. The IEEE 802.11 access control achieves an carrier sense multiple access with collision avoidance (CSMA/CA), in which the use state of the wireless environment is first observed and it is then determined whether frames can be transmitted or not.

Furthermore, the MAC 202 adds an MAC header to any data to transmit, and transmits an acknowledgement (Ack) frame on receiving a data frame that is one of some types of a MAC frame of the 802.11 Standard.

Moreover, if any one of the registered STAs is disconnected, the CPU 201 supplies, to the MAC 202, a request for a pseudo frame equivalent to a frame transmitted and received between the AP and the STA disconnected.

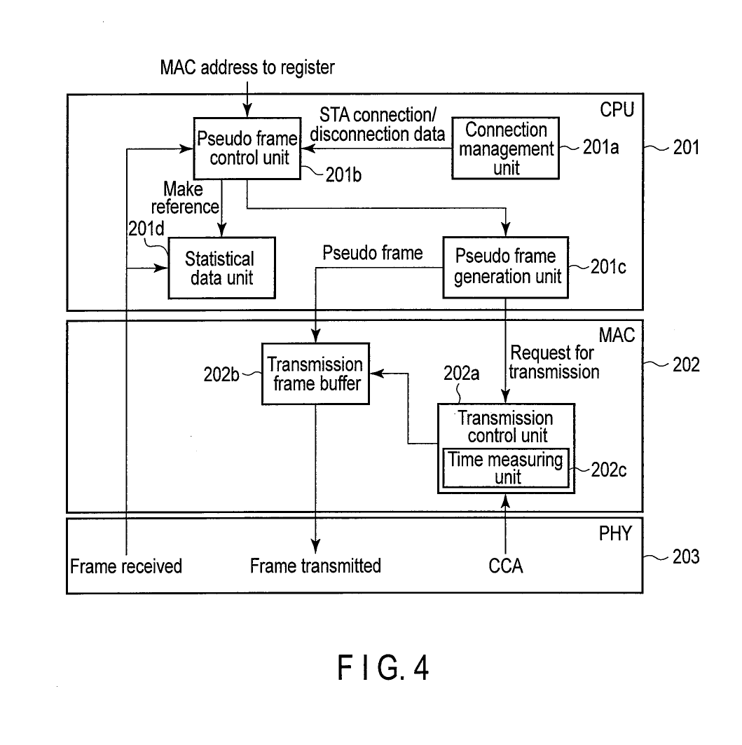

FIG. 4 shows how the CPU 201 processes a pseudo frame by software. More precisely, FIG. 4 shows an exemplary software configuration of the CPU 201 and an exemplary configuration of the MAC 202.

The CPU 201 then controls a connection management unit 201a, a pseudo frame control unit 201b, a pseudo frame generation unit 201c, and a statistical data unit 201d.

### Connection Management Unit 201a

The connection management unit 201a has the function of a detector, and can determine whether each of registered station has been connected or not. That is, the connection management unit 201a determines whether each of registered station is connected to the AP 100 and notifies it to the pseudo frame control unit 201b.

### Pseudo Frame Control Unit 201b

In this embodiment, the pseudo frame control unit 201b registers, for example, the MAC addresses of stations, and controls the generation of pseudo frames. Pseudo communication, which consists of transmission of pseudo frames, is performed when the registered stations are absent. STAs 101 to 103 are registered for pseudo communication in the following example.

More specifically, at an appropriate timing the pseudo frame control unit 201b instructs the pseudo frame generation unit 201c to generate and transmit pseudo frames, if the connection management unit 201a informs it that any one of the STA 101 to 103 is not connected to the AP 100 or if none of the STAs 101 to 103 are not connected to the AP 100.

The phrase of “an appropriate timing” means, for example, upon lapse of a prescribed time after the STAs 101 to 103 which are registered for pseudo communication have been disconnected from the AP 100. In pseudo communication, it is desirable that the pseudo frames are transmitted in accordance with their communication pattern (characteristics) of the imitated station. The communication pattern includes frame interval, frame rate, frame length, etc. The communication pattern is based on the history of received frames, which is held in the statistical data unit 201d.

When informed, by the connection management unit 201a, that the STAs 101 to 103 have been disconnected from the AP 100, the pseudo frame control unit 201b instructs the pseudo frame generation unit 201c to generate and transmit pseudo frames.

When the pseudo frame control unit 201b transmits a request for pseudo frames to the pseudo frame generation unit 201c, it may instruct the pseudo frame generation unit 201c to transmit data frames and an the corresponding acknowledgement (Ack) frame.

Furthermore, the pseudo frame control unit 201b may instruct the pseudo frame generation unit 201c to transmit data frames, but not the acknowledgement frame, at a specific probability.

The connection management unit 201a may inform the pseudo frame control unit 201b that the registered STAs 101 to 103 are connected to the AP 100. In this case, the pseudo frame control unit 201b instructs the pseudo frame generation unit 201c to stop generating and transmitting pseudo frames.

Moreover, the pseudo frame control unit 201b may directly refer to the frame received and may instruct the pseudo frame generation unit 201c to stop generating and transmitting pseudo frames if it receives any frame transmitted from the registered STAs 101 to 103.

After generating a request for the generation and transmission of pseudo frames, the pseudo frame control unit 201b may instruct the pseudo frame generation unit 201c to stop generating and transmitting pseudo frames, upon lapse of a specific time.

### Pseudo Frame Generation Unit 201c

The pseudo frame generation unit 201c generates pseudo frames on receiving the instruction from the pseudo frame control unit 201b, so that the pseudo frames may be transmitted to the STAs 101 to 103 registered in the pseudo frame control unit 201b. These pseudo frames are generated on the basis of, for example, frame interval, frame rate and frame length supplied from the pseudo frame control unit 201b. Furthermore, the pseudo frame generation unit 201c may generate pseudo data frames and a pseudo acknowledgement frame, or only a pseudo data frame, in some cases.

The frames generated are supplied to a transmission frame buffer 202b. The transmission frame buffer 202b is shown as if incorporated in the MAC 202, for convenience of explanation. Nonetheless, the SRAM 206 shown in FIG. 3 functions as transmission frame buffer 202b.

Moreover, the pseudo frame generation unit 201c supplies a transmission request to the transmission control unit 202a provided in the MAC 201.

### Statistical Data Unit 201d

The statistical data unit 201d holds the history data about the frames the AP 100 has received from the registered STAs 101 to 103. The history data shows the frame interval, the frame rate, the frame length, etc. The history data is referred to by the pseudo frame control unit 201b. The pseudo frame control unit 201b may utilize the history data as the communication pattern characteristics of the STAs 101 to 103. Note that the STAs 101 to 103 differ from one another in terms of frame interval, frame rate, frame length, traffic amount, etc. Therefore, the pseudo frame control unit 201b holds the communication patterns of the STAs 101 to 103, and controls the generation of pseudo frames in accordance with the communication patterns of STAs 101 to 103. This is why the AP 100 can operate as if the STAs are communicating with the AP 100.

### MAC 202

The MAC 202 has a time measuring unit 202c, in addition to the transmission control unit 202a. On receiving a transmission request from the pseudo frame generation unit 201c, the transmission control unit 202a transmits the transmission frame held in the transmission frame buffer 202b to the PHY 203 in accordance with the 802.11-standard protocol, in consideration of the clear channel assessment (CCA) supplied from the PHY 203 and back-off time.

Thereafter, in the transmission control unit 202a, the time measuring unit 202c measures time. The transmission control unit 202a transmits an ACK frame held in the transmission frame buffer, to the PHY 203, so that a frame may be transmitted upon lapse of a short inter-frame space (SIFS).

### Operation

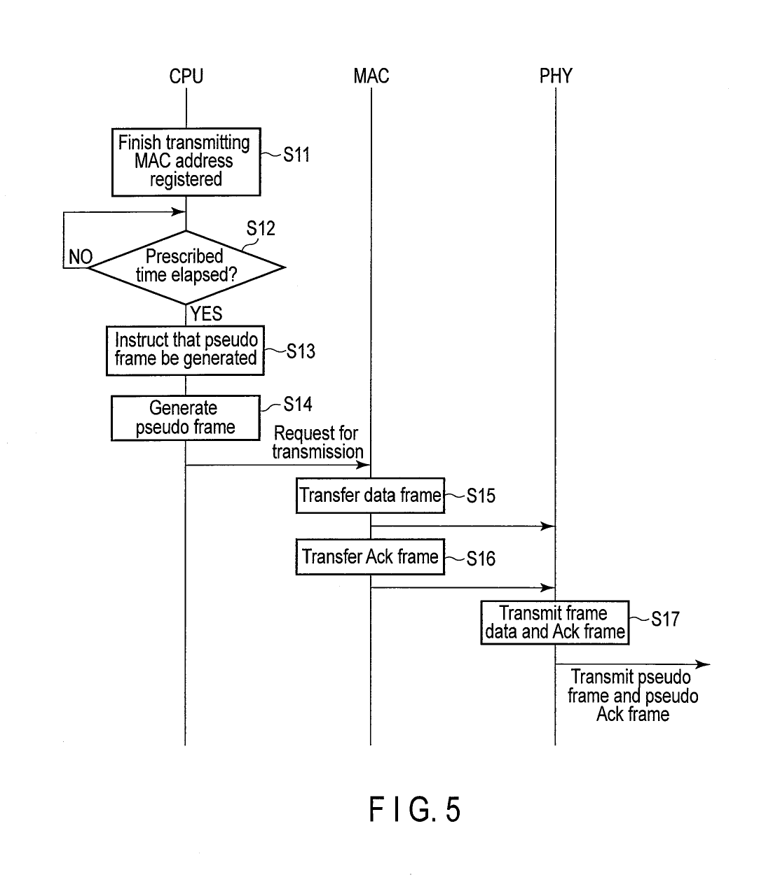

FIG. 5 explains an exemplary operation performed by the wireless communication apparatus described above.

Assume that the MAC addresses of the STAs 101 to 103 are registered in the pseudo frame control unit 201b.

Then, the CPU 201 determines whether the STAs 101 to 103 are connected to the AP 100. If at least one of the STAs 101 to 103 has been disconnected from AP 100, it informs the pseudo frame control unit 201b of this fact (S11).

If informed that at least one of the STAs 101 to 103 has been disconnected from AP 100, after a prescribed time or any given time (S12), the pseudo frame control unit 201b instructs the pseudo frame generation unit 201c to generate and transmit pseudo frames (S13). At this point, the pseudo frame control unit 201b indicates to transmit pseudo frames to the pseudo frame generation unit 201c, giving the MAC address and communication pattern (for example, frame interval, frame rate and frame length) of the STA disconnected from the AP 100.

In accordance with the instruction coming from the pseudo frame control unit 201b, the pseudo frame generation unit 201c generates pseudo frames that accord with the MAC address and communication pattern of the STA disconnected. The pseudo frames generated are transferred to the transmission frame buffer 202b, and also transmits the transmission request to the transmission control unit 202a of the MAC 202 (S14).

Thus, the pseudo frame generation unit 201c generates data frames addressed to a source address A1 (MAC address) and a destination address A2, and also an acknowledgement frame addressed to the source address A1 for the data frames. The data frames and the acknowledgement frame are delivered to the transmission frame buffer 202b.

The sequence numbers of pseudo frames are managed for each STA connected to the AP 100. For example, sequence numbers 101, 102, 103, . . . are assigned to the frames of the STA 1, sequence numbers 325, 326, 327, . . . are assigned to the frames of the STA 2.

In response to the transmission request, the transmission control unit 202a buries data in the field of the data frame held in the transmission frame buffer 202b. The transmission control unit 202a then transfers the data to the PHY 203 (S15) in accordance with the 802.11-standard protocol, in consideration of the CCA supplied from the PHY 203 and back-off time.

Thereafter, in the transmission control unit 202a, the time measuring unit 202c measures time. The transmission control unit 202a transfers the acknowledgement frame held in the transmission frame buffer 202b, to the PHY 203, so that the acknowledgement frame may be transmitted upon lapse of the SIFS time (S16).

The data frame and the acknowledgement frame transferred to the PHY 203 are sequentially transmitted (S17). That is, a pseudo data frame which is equivalent to the data frame the STA disconnected transmits to the AP 100, and a pseudo ACK frame which is equivalent to the ACK frame the AP 100 transmits to the STA can be transmitted from the AP 100. Also, a pseudo data frame which is equivalent to the data frame the AP transmits to the disconnected STA, and a pseudo ACK frame which is equivalent to the ACK frame the disconnected STA transmits to the AP can be transmitted from the AP 100.

The CPU 202 repeats Steps S13 to S17 for registered STAs disconnected from the AP 100.

If the connection management unit 201a detects that the registered STA disconnected has been connected to the AP 100 again, the sequence of Steps S13 to S17 is terminated.

The difference in user transmission pattern can be reflected on the pseudo frames. For example, a user of

STAs transmits and receives a large file such as movies or images, and another user of STAs browses the Web, the pseudo communication pattern may greatly differ from one user to another. Therefore, it can be reflected on the pseudo communications by changing, for example, transmission interval or size of pseudo frames.

To make an STA keep connected to the AP, connection-maintenance sequence, in which STA transmits Null frames when the STA is inactive or there are no actual frames, is sometimes performed by the STA. In the embodiment, the AP 100 may transmit, for example, an equivalent Null frame and the corresponding ACK frame at regular intervals when the STA is absent, thereby to accomplish a pseudo connection-maintenance sequence.

For any STA not kept connected to the AP 100, the AP 100 may stop, at random intervals, the transmission of pseudo data frames, and does not perform the pseudo connection-maintenance sequence. In this way, AP 100 can behave as STA which does not keep its connection when the STA is inactive.

Note that pseudo acknowledgement frames may not be transmitted at some probability. In this case, the embodiment can become more reliable.

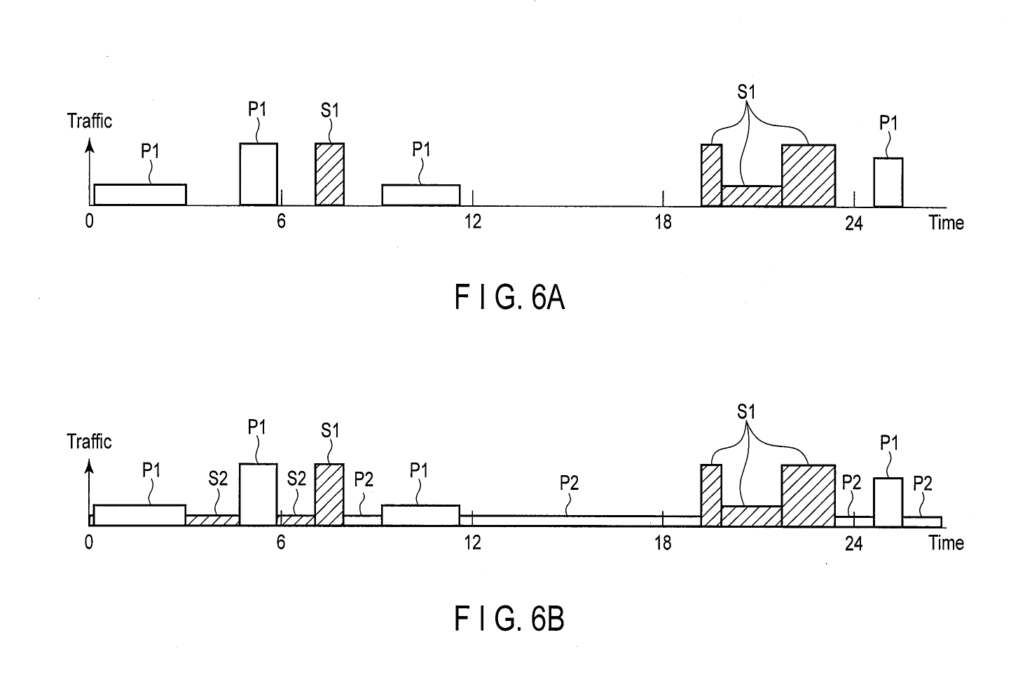

FIGS. 6A and 6B show an exemplary operation the embodiment may perform. In FIGS. 6A and 6B, S1 indicates the transmission and reception of normal data frames, S2 indicates the transmission and reception of frames, achieving a normal connection-maintenance sequence. Furthermore, P1 indicates the transmission and reception of pseudo data frames, and P2 indicates the transmission and reception of pseudo data frames, achieving a pseudo connection-maintenance sequence.

More precisely, FIG. 6A shows how an STA transmits and receives data frames if the STA doesn't keep the connection to the AP 100 when it is inactive. After the STA is disconnected from the AP 100 upon transmitting and receiving normal data frames (see S1), it transmits pseudo data frames upon lapse of a prescribed time or any given time.

FIG. 6B shows how the STA performs a pseudo connection-maintenance sequence. The transmission and reception P2 of pseudo data frames is started after the STA is disconnected from the AP 100 upon transmitting and receiving normal data frames (see S1). Furthermore, the transmission and reception P1 of pseudo data frames is started after upon lapse of a specific time or a given time.

According to the embodiment, when at least one of the STAs 101 to 103 is disconnected from the AP 100, the AP 100 transmits, pseudo transmission frames similar to those transmitted to the STA connected to the AP 100 upon lapse of a specific time or a given time. It is therefore difficult to determine the communication state in the house, from outside. Hence, even if the user of STA (and the STA) does not exist in the house, the user seems to be at home to anyone outside the house. This is useful in view of security. Also, the life situation of the user of the station can not be detected easily.

For the STA that can perform the connection maintaining sequence, the AP 100 performs the connection maintaining sequence even if the user of STA (and the STA) does not exist in the house. Therefore, the user seems to be at home to anyone outside the house. This is also useful in view of security. Also, the life situation of the user of the station can not be detected easily.

Moreover, the AP 100 has the statistical data unit 201d, which holds the history data about the frames received in the past from the STAs 101 to 103. The history data contains the frame interval, frame rate, frame length, etc. The pseudo frame control unit 201b refers to the history data, and controls the generation of pseudo frames in accordance with the history data. The STAs 101 to 103 can therefore appear as if communicating with the AP 100. This helps enhance the credibility of the pseudo frames.

The embodiment has been described based on the assumption that the CPU 201 executes software. The embodiment is not limited to this case, nevertheless. Hardware can be used instead. In this case, it suffices to replace the components of the CPU 201, which are shown in FIG. 4, with hardware components.

The embodiment described above is incorporated in the AP. Nonetheless, it need not be provided always in the AP.

The embodiment described above transmits pseudo data frames. Nonetheless, it may transmit other types of pseudo frames including management frames.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a detection unit configured to detect whether a registered station is communicating;
a generation unit configured to generate a pseudo frame similar to a frame the registered station transmits and receives, if the registered station is detected not communicating; and
a transmission unit configured to transmit the pseudo frame generated by the generation unit.

2. The apparatus according to claim 1, wherein the generation unit stops generating the pseudo frame if the detection unit detects that the registered station is communicating.

3. The apparatus according to claim 2, further comprising a control unit storing a MAC address of the station and configured to request the generation unit to generate the pseudo frame if the detection unit detects that the registered station is not communicating and to cause the control unit to stop requesting to generate the pseudo frame if the detecting unit detects that the registered station is communicating.

4. The apparatus according to claim 3, wherein the control unit controls at least one of the transmission interval, transmission rate and length of the pseudo frame.

5. The apparatus according to claim 3, further comprising a holding unit holding a history of frames received from the registered station,
wherein the control unit controls at least one of the transmission interval, transmission rate and length of the pseudo frame, based on the history held in the holding unit.

6. The apparatus according to claim 3, wherein the generation unit generates a pseudo frame to maintain communication, if the detection unit detects that the registered station is not communicating.

7. The apparatus according to claim 2, wherein the control unit requests to generate a pseudo frame in accordance with the sequence number of the station.

8. The apparatus according to claim 2, which is an access point.

9. The apparatus according to claim 2, wherein the station includes at least one apparatus selected from the group consisting of a mobile telephone and a personal computer.

10. The apparatus according to claim 1, wherein the transmission unit transmits a pseudo acknowledgement frame after transmitting the pseudo frame.

11. A wireless communication method comprising:
detecting whether a registered station is communicating, with an access point;
generating, at the access point, a pseudo frame similar to a frame the registered station transmits and receives, if the registered station is detected not communicating; and
transmitting the pseudo frame generated.

12. The method according to claim 11, wherein the access point stops generating the pseudo frame if the access point detects that the registered station is communicating.

13. The method according to claim 11, wherein the access point transmits a pseudo acknowledgement frame after transmitting the pseudo frame.
